(19) United States
(12) Patent Application Publication
(10) Pub. No.: US 2026/0316257 A1
(43) Pub. Date: Oct. 15, 2026

(54) ROBOT

(71) Applicant: KAWASAKI JUKOGYO KABUSHIKI KAISHA, Hyogo (JP)

(72) Inventors: Masayuki KAMON, Kobe-shi (JP); Hitoshi KUBO, Kobe-shi (JP); Tomoki OKA, Kobe-shi (JP)

(73) Assignee: KAWASAKI JUKOGYO KABUSHIKI KAISHA, Hyogo (JP)

(21) Appl. No.: 19/486,162

(22) PCT Filed: May 24, 2024
(86) PCT No.: PCT/JP2024/019195

§ 371 Date: Nov. 20, 2025

(30) Foreign Application Priority Data
May 30, 2023 (JP) 2023-089092

(51) Int. Cl. B25J 5/00; B25J 9/08; B25J 9/16; B25J 19/00

(52) U.S. Cl. CPC B25J 5/007; B25J 9/08; B25J 9/1664; B25J 19/005

(57) ABSTRACT

A robot (100) includes a robot main body (10) including a robot arm (13, 14), and a mover (20) configured to switchably move integrally with the robot main body (10) and move separately from the robot main body (10).

### TECHNICAL FIELD

The present disclosure relates to a robot.

### BACKGROUND ART

Conventionally, a self-propelled robot including an arm is disclosed. Japanese Patent Laid-Open No. 2020-131377 discloses a self-propelled robot including a traveling base and an arm support. In the self-propelled robot disclosed in Japanese Patent Laid-Open No. 2020-131377, the traveling base rotationally drives a pair of drive wheels to move a robot body. The arm support supports an end of an arm and is disposed integrally with the arm on an upper portion of the traveling base.

### PRIOR ART

### Patent Document

Patent Document 1: Japanese Patent Laid-Open No. 2020-131377

### SUMMARY OF THE INVENTION

However, while performing a predetermined task by operating the arm, the self-propelled robot described in Japanese Patent Laid-Open No. 2020-131377 cannot move to a location away from a location at which the robot is performing the task. On another front, when performing a task that involves movement, such as transporting, cleaning, or patrolling, this self-propelled robot cannot perform a task that involves the continuous operation of the arm at one location. Therefore, it is desired to improve the degree of freedom of robot operation when a plurality of types of tasks, including a task that involves the operation of the robot arm and a task that involves movement, are performed.

The present disclosure is intended to solve the above problems. The present disclosure aims to provide a robot in which the degree of freedom of robot operation can be improved when a plurality of types of tasks, including a task that involves the operation of a robot arm and a task that involves movement, are performed.

A robot according to an aspect of the present disclosure includes a robot main body including a robot arm, and a mover configured to switchably move integrally with the robot main body and move separately from the robot main body. The term “switchably” here indicates that the mover can selectively take one of two states: one in which the mover moves integrally with the robot main body, and one in which the mover moves separately from the robot main body.

As described above, the robot according to this aspect of the present disclosure includes the mover configured to switchably move integrally with the robot main body and move separately from the robot main body. Accordingly, when the robot main body moves integrally with the mover, the robot main body can perform tasks at a plurality of locations using the robot arm disposed on the robot main body while moving with the mover. When the mover moves separately from the robot main body, the mover can perform a task that involves movement such as transportation, while the robot arm performs another task. Consequently, the degree of freedom of robot operation can be improved when a plurality of types of tasks, including a task that involves the operation of the robot arm and a task that involves movement, are performed.

According to the present disclosure, it is possible to improve the degree of freedom of robot operation when the plurality of types of tasks, including the task that involves the operation of the robot arm and the task that involves movement, are performed.

### BRIEF DESCRIPTION OF THE DRAWINGS

FIG. 1 is a diagram showing the overall configuration of a meal serving system in which a robot according to a first embodiment of the present disclosure is disposed.

FIG. 2 is a block diagram showing the configuration of the meal serving system including the robot according to the first embodiment.

FIG. 3 is a perspective view schematically showing the overall configuration of the robot according to the first embodiment.

FIG. 4 is a diagram for illustrating a state in which a robot main body and a mover are separated from each other.

FIG. 5 is a diagram showing the meal serving operation when the robot main body and the mover are separated from each other.

FIG. 6 is a diagram showing the operation with the head removed.

FIG. 7 is a schematic view showing the configuration of a robot according to a second embodiment.

FIG. 8 is a diagram showing the meal serving operation with a robot arm separated.

FIG. 9 is a diagram showing the patrol operation of a robot according to a third embodiment.

### MODES FOR CARRYING OUT THE INVENTION

Embodiments embodying the present disclosure are hereinafter described on the basis of the drawings.

### First Embodiment

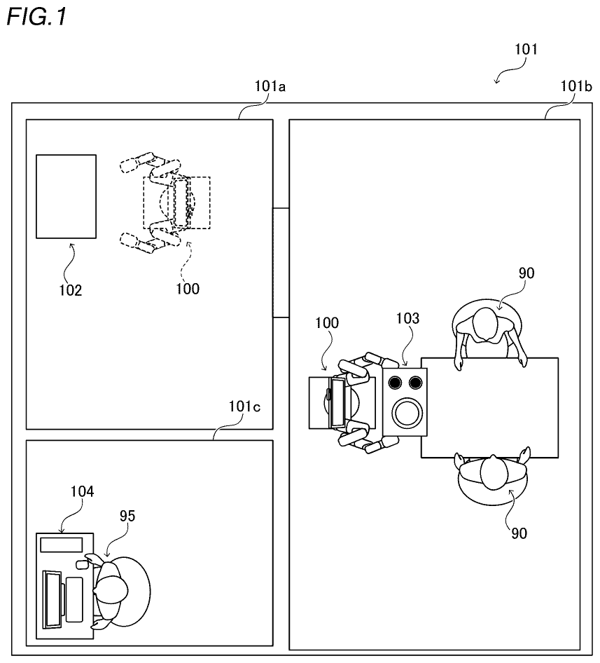

A robot 100 according to a first embodiment is now described with reference to FIGS. 1 to 6.

### Configuration of Meal Serving System

As shown in FIG. 1, the robot 100 is disposed in a meal serving system 101 in which a meal 103 is served to a target person 90. In the meal serving system 101, the robot 100 operates a cooking device 102 to prepare the meal 103. Examples of the cooking device 102 include a microwave oven and a beverage dispenser. The cooking device 102 has the same configuration as a device used by a human, such as a microwave oven or a beverage dispenser. The meal 103 prepared by the robot 100 is then transported to the target person 90 by the robot 100. A cooking room 101a, in which the robot 100 performs a cooking task, and a hall 101b, in which the target person 90 to whom the meal 103 is transported is located, are separate rooms. The robot 100 is a service robot that operates to provide services to users in a human activity space, for example. The robot 100 is also a social robot that communicates face-to-face with humans. The robot 100 performs cooking and transporting tasks while communicating with a control device 104 disposed in a control room 101c. The meal 103 is an example of an object to be transported.

The control device 104 includes a personal computer including an arithmetic unit such as a central processing unit (CPU), storages such as a solid state drive (SSD) or a hard disk drive, a random access memory (RAM), and a read-only memory (ROM), and a communication module, for example. Operation units such as a mouse and a keyboard that receive input operations from an operator 95, and a display that displays images using the arithmetic unit are connected to the control device 104. The control device 104 receives input operations from the operator 95 and transmits, to the robot 100, information instructing the robot 100 on a task to be performed, based on the received input operations. The control device 104 also receives signals from the robot 100 and provides a display based on the information received from the robot 100 on the display.

### Configuration of Robot

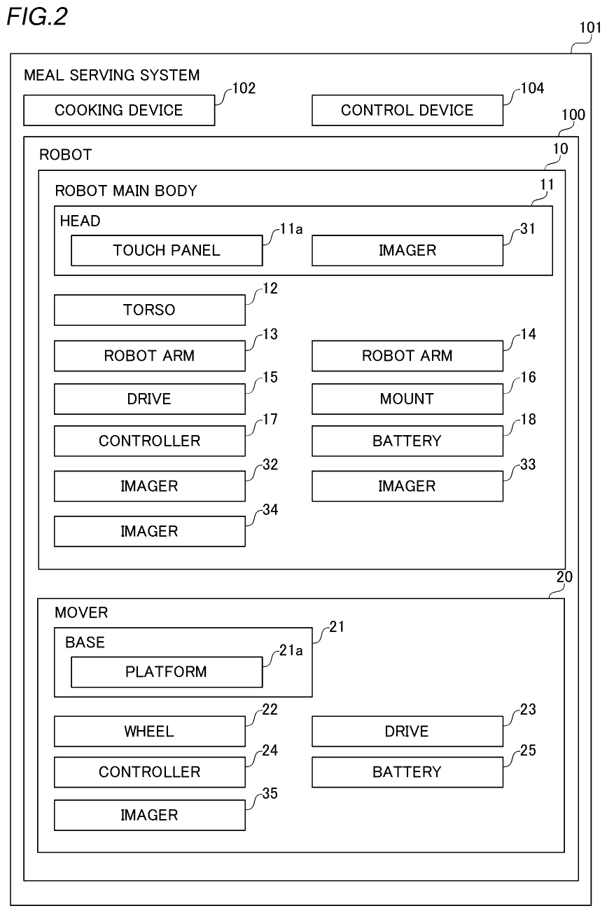

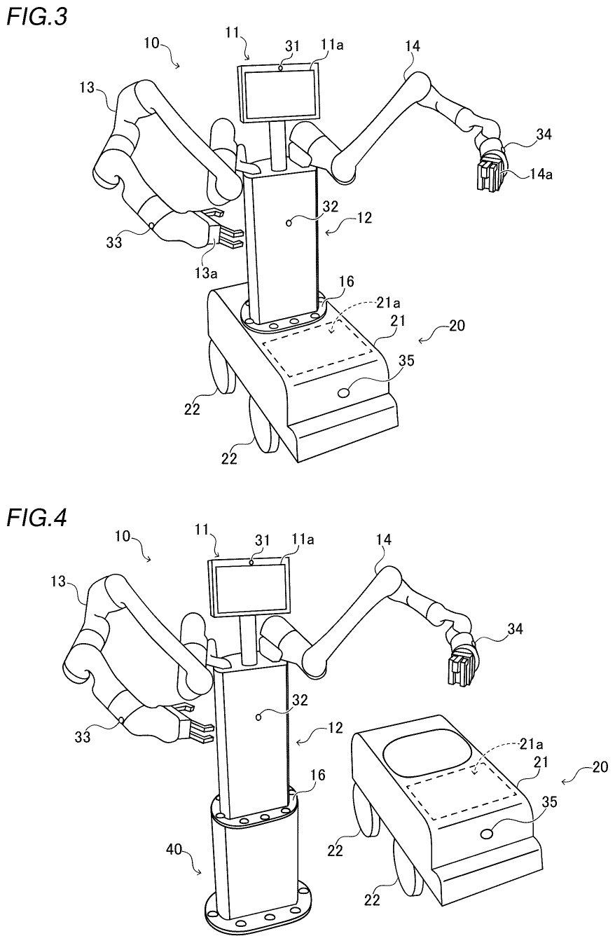

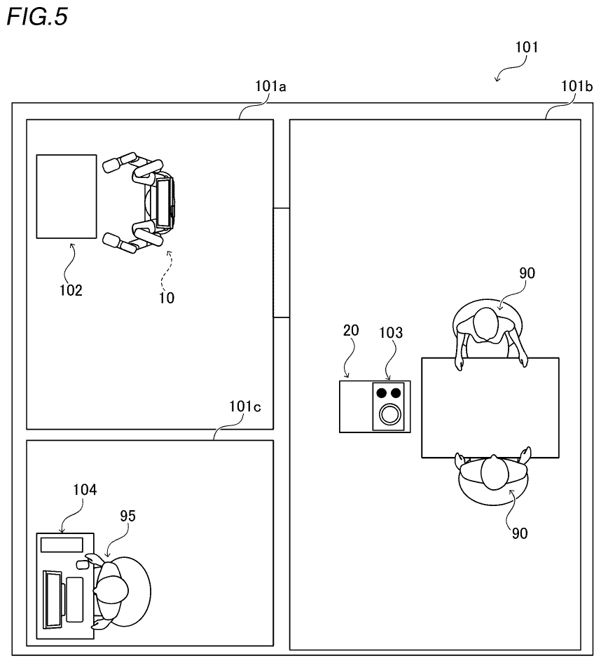

As shown in FIG. 2, the robot 100 includes a robot main body 10 and a mover 20. The robot 100 according to the first embodiment operates by switching between a combined state in which the robot main body 10 moves integrally with the mover 20, and a separated state in which the mover 20 moves independently while separated from the robot main body 10. That is, the robot 100 according to the first embodiment selectively switches between the combined state in which the mover 20 moves integrally with the robot main body 10, and the separated state in which the mover 20 moves separately from the robot main body 10. In other words, the robot 100 can be disposed in either the combined state or the separated state, and is disposed in either the combined state or the separated state. For example, switching between the combined state and the separated state is performed by a switching operation to change the position of the robot main body 10 with respect to the mover 20. In the switching operation, switching is between a combined state in which the robot main body 10 is attached to the mover 20 and a state in which the robot main body 10 is fixed in a location different from the mover 20. FIGS. 1 and 3 show an example of the combined state in which the robot main body 10 and the mover 20 move integrally, while FIGS. 4, 5, and 6 show an example of the separated state in which the robot main body 10 is separated from the mover 20.

As shown in FIG. 2, the robot main body 10 includes a head 11, a torso 12, two different robot arms 13 and 14, a drive 15, and a mount 16. The robot main body 10 also includes a controller 17 and a battery 18. The robot arms 13 and 14 are examples of a first robot arm and a second robot arm, respectively. The controller 17 and the battery 18 are examples of a robot controller and a first battery, respectively. The mover 20 includes a base 21, wheels 22, and a drive 23. The mover 20 also includes a controller 24 and a battery 25. The controller 24 and the battery 25 are examples of a mobile controller and a second battery, respectively. The robot 100 also includes an imager 31, an imager 32, an imager 33, an imager 34, and an imager 35. The imager 31 is an example of a main body imager. The imager 35 is an example of a mobile imager.

### Robot Main Body

As shown in FIG. 3, the head 11 is attached to the torso 12. The head 11 includes a touch panel 11a and the imager 31. The touch panel 11a receives input operations. The touch panel 11a displays images based on signals output from the controller 17. The touch panel 11a receives input operations, for example, from the target person 90 or the operator 95 different from the target person 90. Signals indicating input operations received by the touch panel 11a are output to the controller 17. The touch panel 11a displays, for example, an image representing the status of the task being performed by the robot 200. The touch panel 11a also displays an image that resembles a human face. The imager 31 captures images. The imager 31 includes an imaging device such as a charge coupled device (CCD) or a complementary metal oxide semiconductor (CMOS). The imager 31 outputs the captured images to the controller 17. The touch panel 11a and the imager 31 are integrally disposed. For example, a tablet PC including the touch panel 11a and the imager 31 is disposed in the head 11. The tablet PC including the touch panel 11a and the imager 31 in the head 11 includes an arithmetic unit such as a CPU, a storage such as an SSD, and a communication module, and communicates wirelessly with the controller 17. The head 11 also includes a head battery, which is a secondary battery, which receives electric power from the battery 18. For example, the touch panel 11a outputs a signal indicating the received input operation via a control device in the head 11. Similarly, the imager 31 outputs the captured image via the control device in the head 11. The touch panel 11a is an example of an operation unit.

The torso 12 is a housing on which the head 11, the robot arm 13, and the robot arm 14 are disposed. The controller 17 and the battery 18 are disposed inside the torso 12. The robot arm 13 is the right arm of the robot 100, and the robot arm 14 is the left arm of the robot 100. Each of the robot arms 13 and 14 is a vertical articulated arm including a plurality of links and a plurality of joints. Each of the robot arms 13 and 14 is a 6-axis vertical articulated arm, for example. The robot arms 13 and 14 operate when the drive 15 is driven. The drive 15 includes a plurality of servomotors such that each of the robot arms 13 and 14 performs an operation corresponding to each of the six axes. The operation of the drive 15 is controlled by the controller 17. Furthermore, a first end of each of the robot arms 13 and 14 is attached to the torso 12. The robot arm 13 and the robot arm 14 include hands 13a and 14a at second ends thereof, respectively. Each of the hands 13a and 14a includes a plurality of claws that perform opening and closing operations, and is an end effector that grasps, for example, a tray on which the meal 103, which is an object to be transported, is placed or a container for the meal 103, with the claws. The hands 13a and 13b also define and function as end effectors that operate the cooking device 102. In the robot 100, an end effector for performing a predetermined task operation is selected and disposed on each of the robot arms 13 and 14 according to the task to be performed in the system in which the robot 100 is disposed.

The imager 32 is disposed on the torso 12. The imager 33 and the imager 34 are disposed on the robot arm 13 and the robot arm 14, respectively. Each of the imager 32, the imager 33, and the imager 34 captures images and outputs the captured images to the controller 17. Each of the imager 32, the imager 33, and the imager 34 includes an imaging device such as a CCD or a CMOS, similarly to the imager 31.

The mount 16 is disposed on the torso 12. When the robot main body 10 and the mover 20 are in the combined state in which they move integrally, the mount 16 is attached to the base 21 of the mover 20. Specifically, the mount 16 is fixed to the upper surface of the base 21, which is the surface on the vertically upper side, by fastening with fasteners such as screws. The mount 16 is attached to the base 21 such that the robot main body 10 is attached to the mover 20. For example, the mount 16 has a flange-like shape that extends along the upper surface of the base 21 on the bottom side of the torso 12. Fastening holes are disposed in the mount 16 and the base 21, and the mount 16 is fixed to the base 21 by the operator 95 fastening the fasteners into the fastening holes.

The controller 17 controls the operation of each portion of the robot main body 10. For example, the controller 17 controls the operation of the robot arm 13 including the hand 13a, the operation of the robot arm 14 including the hand 14a, the display on the touch panel 11a, and imaging by the imagers 31, 32, 33, and 34. The controller 17 includes an arithmetic unit such as a CPU, and storages such as a flash memory such as an SSD, a hard disk drive, a RAM, and a ROM. The controller 17 also includes a communication module. The controller 17 performs a control using programs and parameters stored in the storages. The controller 17 uses the communication module to communicate with the touch panel 11a, the imagers 31, 32, 33, and 34, the controller 24 of the mover 20, and the control device 104 via USB communication, a local area network (LAN), or the Internet, for example.

The battery 18 is disposed in the robot main body 10. The battery 18 is, for example, a secondary battery disposed inside the torso 12 of the robot main body 10. The battery 18 serves as a power source for the operation of the robot main body 10. For example, the battery 18 supplies electric power as a drive source for causing the head battery of the head 11, the drive 15, and the controller 17 to operate. In the first embodiment, the battery 18 serves as a power source for the robot arms 13 and 14.

### Mover

The base 21 is a housing of the mover 20. When the mover 20 moves integrally with the robot main body 10, the robot main body 10 is attached to the upper surface of the base 21. The base 21 includes the wheels 22 on its bottom side. The base 21 houses the drive 23, the controller 24, and the battery 25. The mover 20 includes a platform 21a on which the meal 103 is placed. The platform 21a is disposed on the upper surface of the base 21. When the robot 100 performs a task to transport the meal 103, the mover 20 moves with the meal 103 placed on the platform 21a.

The wheels 22 are disposed as four wheel members, for example. The four wheel members are disposed two on each side of the mover 20 in a right-left direction. The wheels 22 are attached to the base 21 to support the base 21. The wheels 22 rotate when the drive 23 is driven. The drive 23 includes a servomotor that rotates each wheel 22. The drive 23 performs a rotational operation under the control of the controller 24 to output a driving force to rotate the wheels 22. When the drive 23 is driven, the wheels 22 rotate, causing the mover 20 to move. The wheels 22 include a direction change mechanism that changes the movement direction of the mover 20.

The imager 35 is disposed on the mover 20. The imager 35 is disposed on the front side of the base 21. The imager 35 is disposed on the base 21, and thus the imager 35 captures images while moving integrally with the mover 20. The imager 35 includes an imaging device such as a CCD or a CMOS. The imager 35 outputs the captured images to the controller 24.

The controller 24 controls the operation of each portion of the mover 20. For example, the controller 24 controls movement of the mover 20 and acquisition of images captured by the imager 35. The controller 24 is disposed in the mover 20 separately from the controller 17 disposed in the robot main body 10. Similarly to the controller 17, the controller 24 includes an arithmetic unit such as a CPU and storages. The controller 24 performs a control using programs and parameters stored in the storages. The controller 24 also includes a communication module and communicates with the controller 17 of the robot main body 10 and the control device 104.

The battery 25 is disposed in the mover 20 separately from the battery 18 disposed in the robot main body 10. For example, the battery 25 is a secondary battery disposed inside the base 21. The battery 25 serves as a power source for movement of the mover 20. For example, the battery 25 supplies electric power as a power source for causing the drive 23 and the controller 24 to operate. In the first embodiment, the battery 25 supplies electric power as a power source for rotating the wheels 22 to the drive 23 in the mover 20.

### Operation in Combined State

As shown in FIG. 1, when the robot 100 is disposed in the combined state in the meal serving system 101, the robot 100 operates the cooking device 102 and transports the meal 103 in a state in which the robot main body 10 and the mover 20 move integrally. For example, the controller 17 and the controller 24 of the robot 100 acquire the details of the cooking and transporting tasks based on signals from the control device 104 or input operations on the touch panel 11a by people including the target person 90 and the operator 95. The details of the cooking task include, for example, information indicating the type of meal 103 to be cooked using the cooking device 102. The details of the transporting task include information indicating the position of the target person 90 to which the meal 103 is to be transported. Based on the acquired details of the cooking task, the robot 100 operates the robot arm 13 including the hand 13a and the robot arm 14 including the hand 14a under the control of the controller 17 to operate the cooking device 102. The controller 17 operates the cooking device 102 by operating the robot arms 13 and 14 based on preset control amounts and image recognition of images captured by the imagers 31, 32, 33, and 34, for example. After cooking of the meal 103 using the cooking device 102 is completed, the robot 100 transports the meal 103 to the position of the target person 90 by moving the robot main body 10 and the mover 20 integrally under the control of the controller 24, with the meal 103 placed on the platform 21a of the mover 20. The controller 24 moves the mover 20 based on preset map information of the cooking room 101a and the hall 101b, position information of the target person 90 to which the meal 103 is to be transported, and image recognition of images captured by the imager 35, for example. Then, the robot 100 operates the robot arms 13 and 14 under the control of the controller 17 to move the meal 103 from the platform 21a to a table or the like at which the target person 90 is located.

The controller 17 of the robot main body 10 and the controller 24 of the mover 20 perform the cooking and transporting tasks while communicating with each other. The controllers 17 and 24 also transmit information indicating the operating status of the robot 100 to the control device 104. The controllers 17 and 24 control the operations of the robot arms 13 and 14 and the movement of the mover 20 based on signals from the control device 104. For example, when an abnormality occurs in the operation of the robot 100 or when the robot 100 performs an operation different from a preset operation, an operation signal for controlling the operation of the robot 100 is transmitted from the control device 104 to the robot 100 based on an input operation to the control device 104 by the operator 95. The controller 17 of the robot main body 10 and the controller 24 of the mover 20 of the robot 100 control the operation of each portion of the robot main body 10 and the mover 20 based on the operation signal acquired from the control device 104, respectively. That is, the robot 100 operates by switching between autonomous operation and remote control.

### Operation in Separated State

As shown in FIG. 4, when the robot 100 is disposed in the separated state in the meal serving system 101, the robot 100 operates the cooking device 102 and transports the meal 103 in a state in which the robot main body 10 and the mover 20 are separated from each other. In other words, in the first embodiment, the mover 20 moves by switching between moving integrally with the robot main body 10 and moving separately from the robot main body 10.

When the robot main body 10 moves integrally with the mover 20, the robot main body 10 is attached to the base 21, and when the mover 20 moves separately, the robot main body 10 is fixed separately from the mover 20. The robot main body 10 is fixed separately from the mover 20 by attaching the mount 16 to a stand 40 that is placed on the floor separately from the mover 20. The stand 40 is fixed to the floor of the cooking room 101a by fastening with fasteners such as screws.

As shown in FIG. 5, when the mover 20 moves separately from the robot main body 10, the mover 20 moves with the meal 103, which is an object to be transported that is separate from the robot main body 10, placed on the platform 21a. While the mover 20 is moving, the robot main body 10 performs a predetermined task operation by operating the robot arms 13 and 14. That is, in the robot 100 in the separated state, while the mover 20 performs a transporting task involving movement of the meal 103, the robot main body 10 performs a cooking task using the cooking device 102 by operating the robot arms 13 and 14.

The controller 17 disposed in the robot main body 10 and the controller 24 disposed in the mover 20, which moves separately from the robot main body 10, each execute a control process based on the programs and the parameters stored in the storages such that the robot main body 10 and the mover 20 operate independently while separated from each other. That is, the controller 17 disposed in the robot main body 10 controls the operations of the robot arm 13 and the robot arm 14, and the controller 24 disposed in the mover 20, which moves separately from the robot main body 10, controls the movement of the mover 20. Even when the robot main body 10 and the mover 20 operate separately from each other, the controller 17 and the controller 24 transmit and receive signals to and from each other. For example, the controller 17 and the controller 24 transmit and receive information indicating the positional relationship between the robot main body 10 and the mover 20 or the operating status of the robot main body 10 and the mover 20 to and from each other. Furthermore, each of the controller 17 and the controller 24 transmits and receives signals to and from the control device 104 even when the mover 20 moves separately from the robot main body 10. For example, even when the mover 20 moves separately from the robot main body 10, the operations of the robot main body 10 and the mover 20 are controlled by remote control when an operation signal is acquired from the control device 104.

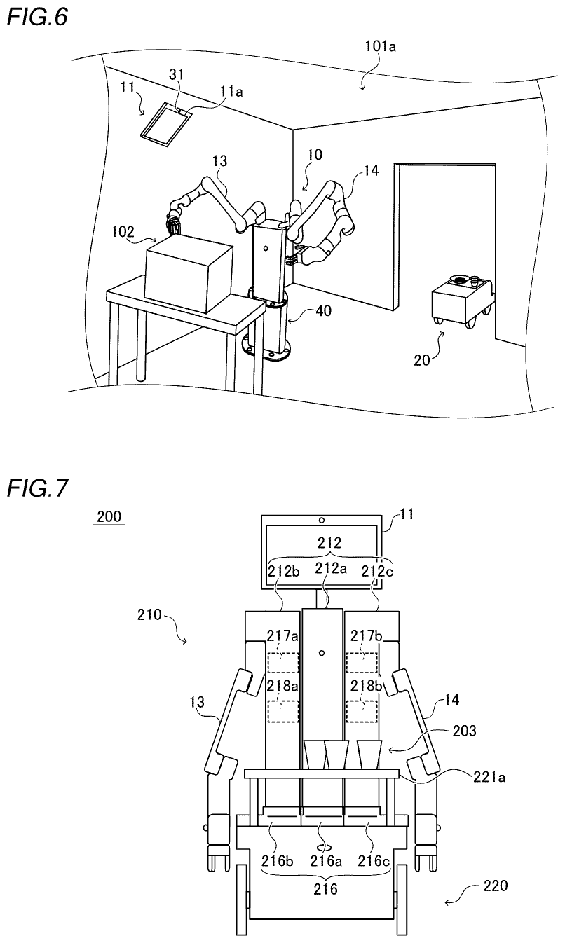

As shown in FIG. 6, even when the head 11, on which the touch panel 11a and the imager 31 are disposed, is detached from the torso 12, the robot 100 operates in the same manner as when the head 11 is attached to the torso 12. That is, in the first embodiment, the touch panel 11a and the imager 31 are switchable between being attached to the torso 12 of the robot main body 10 and being separated from the torso 12 of the robot main body 10. For example, the head 11 is disposed on the wall surface of the cooking room 101a. In such a case, the imager 31 is spaced apart from the robot main body 10, which is performing a cooking task using the cooking device 102. The imager 31 images the robot main body 10 from a position spaced apart from the robot main body 10. In such a case as well, the controller 17 of the robot main body 10 controls the operations of the robot arms 13 and 14 based on the image captured by the imager 31 and the images captured by the imagers 32, 33, and 34.

### Advantageous Effects of First Embodiment

According to the first embodiment, as described above, the robot 100 includes the mover 20 configured to switchably move integrally with the robot main body 10 and move separately from the robot main body 10. Accordingly, when the robot main body 10 moves integrally with the mover 20, the robot main body 10 can perform tasks at a plurality of locations using the robot arms 13 and 14 disposed on the robot main body 10 while moving with the mover 20. When the mover 20 moves separately from the robot main body 10, the mover 20 can perform a task that involves movement such as transportation, while the robot arms 13 and 14 perform another task. Consequently, the degree of freedom of robot operation can be improved when a plurality of types of tasks, including a task that involves the operations of the robot arms 13 and 14 and a task that involves movement, are performed.

The mover 20 includes the platform 21a on which the meal 103, which is an object to be transported that is separate from the robot main body 10, is placed. Accordingly, the meal 103 is placed on the platform 21a, and thus the mover 20 can perform a task to transport the meal 103. Therefore, even when the robot main body 10 is performing a task involving the operations of the robot arms 13 and 14, the mover 20, which moves separately from the robot main body 10, can perform a meal 103 transportation task involving movement. Consequently, the degree of freedom of robot operation can be effectively improved when a plurality of types of tasks, including transportation of the meal 103, are performed.

The robot 100 includes the controller 17, which is a robot controller disposed in the robot main body 10 and configured or programmed to control the operations of the robot arms 13 and 14. The robot 100 also includes the controller 24, which is a mobile controller disposed in the mover 20 separately from the controller 17 and configured or programmed to control movement of the mover 20. Accordingly, when the robot main body 10 and the mover 20 are separated from each other, the operation of the robot main body 10 can be controlled by the controller 17, and the operation of the mover 20 can be controlled by the controller 24. Therefore, the robot main body 10 and the mover 20 can easily operate independently of each other, and thus the degree of freedom of robot operation can be easily improved when a plurality of types of tasks are performed.

The mover 20 includes the base 21 to which the robot main body 10 is attached when the mover 20 moves integrally with the robot main body 10. The robot main body 10 includes the mount 16 to be attached to the base 21 of the mover 20. Accordingly, the robot main body 10 can be fixed to the mover 20 by attaching the mount 16 of the robot main body 10 to the base 21 of the mover 20, and thus the robot main body 10 and the mover 20 can easily move integrally with each other.

The robot main body 10 is fixed separately from the mover 20 by attaching the mount 16 to the stand 40 placed on the floor separately from the mover 20 when the mover 20 moves separately from the robot main body 10.

Accordingly, when the mover 20 moves separately from the robot main body 10, the robot main body 10 can be fixed while separated from the mover 20 by attaching the mount 16 of the robot main body 10 to the stand 40. Therefore, when the mover 20 moves separately from the robot main body 10, the robot 100 can operate with the robot main body 10 stably placed.

The robot main body 10 is configured to perform a predetermined task operation by operating the robot arms 13 and 14 when the mover 20 moves separately from the robot main body 10. Accordingly, the robot main body 10 can perform the predetermined task operation using the robot arms 13 and 14 disposed on the robot main body 10 while the mover 20 performs a task that involves movement while separated from the robot main body 10, and thus the degree of freedom of robot operation can be effectively improved when a plurality of types of tasks are performed.

The robot 100 includes the imager 31 as a main body imager switchable between being attached to the robot main body 10 and being separated from the robot main body 10 and configured to capture an image. Accordingly, the imager 31 is switchable between being attached to the robot main body 10 and being separated from the robot main body 10, and thus a subjective image captured when the imager 31 is attached to the robot main body 10 and an objective image captured when the imager 31 is separated from the robot main body 10 can be switchably captured. Therefore, when the operations of the robot arms 13 and 14 are controlled based on the captured image, the type of image captured can be easily switched according to the form or type of task, and thus the operations of the robot arms 13 and 14 can be easily controlled based on the appropriate image.

The robot 100 includes the touch panel 11a as an operation unit on the robot main body 10, which is at least one of the robot main body 10 and the mover 20, to receive an input operation. Accordingly, in the robot main body 10, which is at least one of the robot main body 10 and the mover 20, an instruction for setting the type of task to be performed by the robot 100 can be easily acquired based on the input operation on the touch panel 11a. Therefore, each of the plurality of types of tasks can be easily performed.

The robot 100 includes the battery 18 as a first battery disposed in the robot main body 10 and configured to serve as a power source for the operations of the robot arms 13 and 14. The robot 100 also includes the battery 25 as a second battery disposed in the mover 20 separately from the battery 18 and configured to serve as a power source for movement of the mover 20. Accordingly, in both a case in which the robot main body 10 and the mover 20 move integrally with each other and a case in which the robot main body 10 and the mover 20 move separately from each other, the battery 18 is disposed in the robot main body 10 while the battery 25 is disposed in the mover 20, and thus as compared with a case in which electric power serving as a driving force is supplied via an external power source such as a predetermined power supply device or a system power supply, the degree of freedom in arrangement of the robot main body 10 and the mover 20 can be improved. Furthermore, the robot main body 10 and the mover 20 can be caused to easily operate independently of each other, and the degree of freedom in movement of the mover 20 can be further improved. Consequently, the degree of freedom of robot operation can be further improved when a plurality of types of tasks are performed.

### Second Embodiment

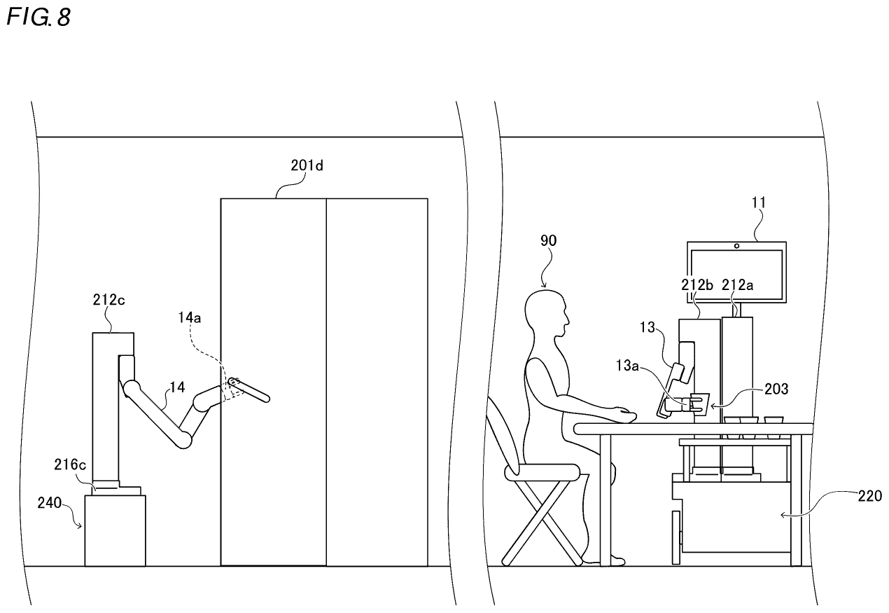

A robot 200 according to a second embodiment is now described with reference to FIGS. 7 and 8. In the second embodiment, robot arms 13 and 14 of the robot 200 operate independently of each other while separated from each other.

As shown in FIG. 7, the robot 200 according to the second embodiment includes a robot main body 210 and a mover 220. The robot 200 is disposed in a meal serving system 101, for example, similarly to the robot 100 according to the first embodiment. In the meal serving system 101, the robot 200 performs a cooking task to pour a beverage 203 into a container using a beverage dispenser, which is a cooking device 102, and performs a transporting task to transport the beverage 203 placed on a platform 221a, for example. The platform 221a is a table-shaped member attached to an upper portion of a base 21 of the mover 220. Similarly to the robot 100 according to the first embodiment, the robot 200 operates by switching between a combined state in which the robot main body 210 moves integrally with the mover 220, and a separated state in which the mover 220 moves separately from the robot main body 210. The beverage 203 is an example of an object to be transported.

The robot main body 210 includes a torso 212 and a mount 216. The torso 212 includes a central portion 212a, a first arm placement portion 212b, and a second arm placement portion 212c. A head 11 is attached to the central portion 212a. The robot arm 13 is placed on the first arm placement portion 212b. The robot arm 14 is placed on the second arm placement portion 212c. The central portion 212a, the first arm placement portion 212b, and the second arm placement portion 212c are each a portion of a housing of the robot main body 210. In the second embodiment, the first arm placement portion 212b to which the robot arm 13 is attached and the second arm placement portion 212c to which the robot arm 14 is attached are placed separately from each other.

The mount 216 is disposed on the torso 212. The mount 216 includes a portion 216a, a portion 216b, and a portion 216c. The portions 216a, 216b, and 216c are disposed on the central portion 212a, the first arm placement portion 212b, and the second arm placement portion 212c, respectively. Similarly to the mount 16 according to the first embodiment, the portions 216a, 216b, and 216c of the mount 216 are attached to the base 21 of the mover 220 by fastening with fasteners such as screws when the robot main body 210 and the mover 220 are in the combined state in which they move integrally. The portions 216a, 216b, and 216c of the mount 216 are attached to the base 21 separately from each other. That is, each of the portions 216a, 216b, and 216c can be removed from the base 21 independently of each other.

The robot main body 210 includes controllers 217a and 217b and batteries 218a and 218b disposed therein. The hardware configuration of each of the controllers 217a and 217b is similar to the hardware configuration of the controller 17 according to the first embodiment. The hardware configuration of each of the batteries 218a and 218b is similar to the hardware configuration of the battery 18 according to the first embodiment. The controller 217a and the battery 218a are disposed in the first arm placement portion 212b of the torso 212. The controller 217a controls the operation of the robot arm 13. The battery 218a supplies electric power to the robot arm 13 and the controller 217a to serve as a power source for the operations of the robot arm 13 and the controller 217a. The controller 217b and the battery 218b are disposed in the second arm placement portion 212c of the torso 212. The controller 217b controls the operation of the robot arm 14. The battery 218b supplies electric power to the robot arm 14 and the controller 217b to serve as a power source for the operations of the robot arm 14 and the controller 217b. The controllers 217a and 217b are examples of a robot controller. The batteries 218a and 218b are examples of a first battery.

In the second embodiment, the robot arm 13 is driven by the controller 217a and the battery 218a, and the robot arm 14 is driven by the controller 217b and the battery 218b, such that the robot arms 13 and 14 operate independently of each other while separated from each other. That is, the controllers 217a and 217b control the operations of the robot arms 13 and 14 independently of each other. The controllers 217a and 217b also communicate with each other. The controllers 217a and 217b each communicate with a touch panel 11a, imagers 31, 32, 33, and 34, the controller 24 of the mover 220, and a control device 104. For example, the imager 33 is disposed on the central portion 212a of the torso 212. The imager 33 transmits a captured image to the controllers 217a and 217b via wireless communication.

In the second embodiment, the mover 220 switchably moves integrally with the robot arms 13 and 14 and moves separately from at least one of the robot arms 13 and 14. As in the first embodiment, when the robot 200 is disposed in the combined state in the meal serving system 101, the mover 220 moves integrally with both the robot arms 13 and 14. That is, the robot 200 operates with the central portion 212a, the first arm placement portion 212b, and the second arm placement portion 212c of the robot main body 210 all attached to the base 21 of the mover 220. Furthermore, as in the first embodiment, when the robot 200 is disposed in the separated state in the meal serving system 101, the robot 200 operates such that the robot main body 210 and the mover 220 perform tasks separately with the entire robot main body 210 and the mover 220 separated from each other. In such a case, the portions 216a, 216b, and 216c of the mount 216 are attached to a stand 40 placed on the floor of a cooking room 101a, such that the entire robot main body 210 performs a task while fixed separately from the mover 220. In other words, when the mover 220 moves separately from the entire robot main body 210, the mover 220 moves separately from both the robot arm 13 and the robot arm 14.

As shown in FIG. 8, in the second embodiment, the robot 200 can be disposed in an arm-separated state in which the mover 220 moves separately from one of the robot arm 13 and the robot arm 14, and moves integrally with the other. For example, of the robot main body 210, the head 11, the central portion 212a of the torso 212, and the first arm placement portion 212b on which the robot arm 13 is placed move integrally with the mover 220. Furthermore, of the robot main body 210, only the second arm placement portion 212c of the torso 212 on which the robot arm 14 is placed is disposed while separated from the mover 220. For example, the second arm placement portion 212c is disposed at the entrance of a hall 101b in which a target person 90 to whom the beverage 203 is to be served is located. Specifically, the portion 216c of the mount 216 is attached, by fasteners such as screws, to a stand 240 fixed to the floor at the entrance of the hall 101b, such that the second arm placement portion 212c is fixed separately from the mover 220 and the robot main body 210 including the central portion 212a and the first arm placement portion 212b. The robot 200 causes the robot arm 14 to independently operate to open and close a door 201d at the entrance of the hall 101b.

The controller 217b of the second arm placement portion 212c, which controls the robot arm 14, recognizes that the mover 220 is approaching the door 201d, for example, by communicating with the controller 217a of the first arm placement portion 212b, the controller 24 of the mover 220, and the control device 104. The controller 217b also recognizes that a person, including the target person 90, is approaching the door 201d based on an image captured by the imager 34 disposed on the robot arm 14. When the controller 217b recognizes the approach of the mover 220 or the approach of the person, the controller 217b causes a hand 14a to grasp the handle of the door 201d and operates the robot arm 14 to open the door 201d.

With the beverage 203 placed on the platform 221a, the robot 200 moves the mover 220 integrally with the robot arm 13 to the position of the target person 90 in the hall 101b under the control of the controller 24. Then, under the control of the controller 217a of the first arm placement portion 212b to which the robot arm 13 is attached, the robot 200 operates the robot arm 13 including a hand 13a to move the beverage 203 from the platform 221a to a table or the like at which the target person 90 is located. The remaining configurations of the second embodiment are similar to those of the first embodiment.

### Advantageous Effects of Second Embodiment

According to the second embodiment, as described above, the robot 200 includes the robot arm 13 as a first robot arm and the robot arm 14 as a second robot arm, which are different from each other. The robot arms 13 and 14 are configured to operate independently of each other while separated from each other. Accordingly, the robot main body 210 includes two robot arms, the robot arm 13 and the robot arm 14, and thus the robot main body 210 including the two robot arms 13 and 14 can perform more complex tasks. Therefore, the robot main body 210, which includes the two robot arms 13 and 14, switches between moving integrally with the mover 220 and being separated from the mover 220 such that the degree of freedom of robot operation can be effectively improved even when a plurality of more complex types of tasks are performed. Furthermore, the robot arms 13 and 14 operate independently of each other while separated from each other, and thus the two robot arms 13 and 14 can perform tasks at different locations. Therefore, the degree of freedom of robot operation can be further improved when a plurality of types of tasks are performed.

The mover 220 is configured to switchably move integrally with the robot arm 13 as the first robot arm and the robot arm 14 as the second robot arm and move separately from at least one of the robot arms 13 and 14. The robot arms 13 and 14 are configured to operate independently of each other when the mover 220 moves separately from at least one of the robot arms 13 and 14. Accordingly, when the mover 220 is moved separately from the two robot arms 13 and 14, the two robot arms 13 and 14 can be operated at different locations while separated from the mover 220, and the mover 220 can perform a task that involves movement. When the mover 220 is moved separately from one (the robot arm 14, for example) of the two robot arms 13 and 14, the robot arm 14 is disposed while separated from the mover 220 such that a task that involves the operation of the robot arm 14 can be performed at one location while a task that involves the operation of the robot arm 13 with movement together with the mover 220 can be performed. Consequently, the degree of freedom of robot operation can be further improved when a plurality of types of tasks are performed. The remaining advantageous effects of the second embodiment are similar to those of the first embodiment.

### Third Embodiment

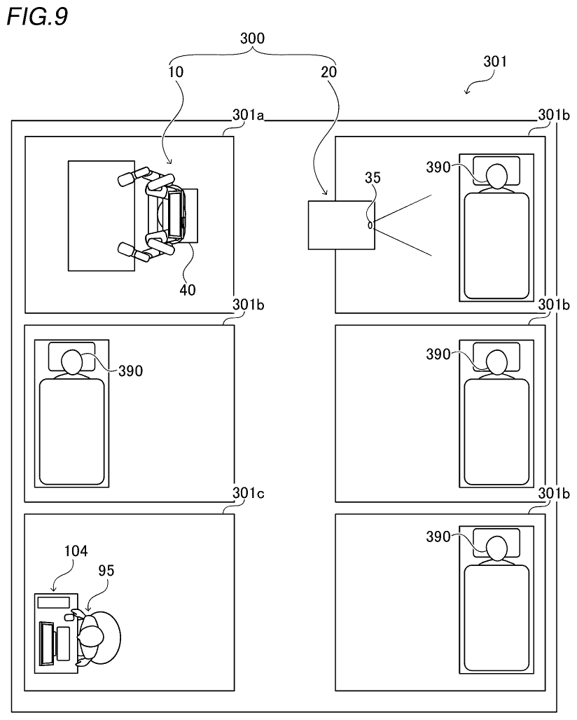

The configuration of a robot 300 according to a third embodiment is now described with reference to FIG. 9. In the third embodiment, the robot 300 performs a patrol task operation using a mover 20.

As shown in FIG. 9, the robot 300 according to the third embodiment is disposed in a patrol system 301. In the patrol system 301, patrols are performed for target persons 390 located in a plurality of bedrooms 301b in a medical institution or a nursing home, for example. The robot 300 according to the third embodiment includes a robot main body 10 and the mover 20. The configurations of the robot main body 10 and the mover 20 are similar to those according to the first embodiment. In the patrol system 301, the robot 300 performs a patrol task operation while communicating with a control device 104 disposed in a control room 301c.

In the patrol system 301, for example, the robot 300 is disposed in a separated state in which the mover 20 moves separately from the robot main body 10. The robot main body 10 is disposed in a work room 301a. Specifically, as in the first embodiment, a mount 16 is fixed to a stand 40 fixed to the floor of the work room 301a, such that the robot main body 10 is fixed separately from the mover 20. In the work room 301a, the robot main body 10 performs, for example, management tasks such as preparing and organizing equipment, or a light task such as processing a specimen, by operating robot arms 13 and 14.

In the third embodiment, the mover 20 moves to patrol each of the plurality of bedrooms 301b while communicating with the control device 104. A controller 24 of the mover 20 transmits images captured by an imager 35 disposed on the mover 20 to the control device 104. The images captured by the imager 35 are displayed on a display of the control device 104. An operator 95 monitors the images displayed on the display of the control device 104 to sequentially check the interiors of the plurality of bedrooms 301b as the mover 20 moves. The mover 20 periodically patrols each of the plurality of bedrooms 301b based on preset position information of the plurality of bedrooms 301b. As in the first embodiment, when an operation signal is transmitted from the control device 104 to the controller 24 of the mover 20, the controller 24 controls movement of the mover 20 based on the operation signal. The remaining configurations of the third embodiment are similar to those of the first embodiment.

### Advantageous Effects of Third Embodiment

According to the third embodiment, as described above, the robot 300 includes the imager 35 as a mobile imager on the mover 20 configured to move integrally with the mover 20. Accordingly, as the mover 20 moves, the imager 35 can image a plurality of locations. Therefore, a task that involves movement using the imager 35, such as inspection, patrol, or testing of the plurality of locations, can be performed. Consequently, the degree of freedom of robot operation can be further improved when a plurality of types of tasks are performed. The remaining advantageous effects of the third embodiment are similar to those of the first embodiment.

### Modified Examples

The embodiments disclosed this time must be considered as illustrative in all points and not restrictive. The scope of the present disclosure is not shown by the above description of the embodiments but by the scope of claims for patent, and all modifications (modified examples) within the meaning and scope equivalent to the scope of claims for patent are further included.

For example, while the example in which the controllers 17, 217a, and 217b are disposed in the robot main bodies 10 and 210 as main body controllers, and the controller 24 is disposed in the movers 20 and 220 as a mobile controller has been shown in the aforementioned first, second, and third embodiments, the present disclosure is not limited to this. In the present disclosure, the main body controller may not be disposed in the robot main body. When the robot main body moves integrally with the mover, the operation of each portion of the robot main body, including the robot arms, may be performed by a control process performed by the mobile controller disposed in the mover. Furthermore, when the mover is moved separately from the robot main body, a connector for inputting a control signal may be provided on the stand on which the robot main body is placed, and the operation of the robot main body may be controlled based on the signal input via the stand. Alternatively, a cable for inputting a control signal may be connected to a portion other than the stand. In such a case, the operation of each portion of the robot main body, including the robot arms, may be performed by a control process performed by a control device disposed separately from the robot. Furthermore, when the mover moves separately from the first robot arm and the second robot arm as in the second embodiment, controllers that control the operations of the first robot arm and the second robot arm may be disposed in stands or the like to which the first robot arm and the second robot arm are fixed, respectively.

While the example in which the batteries 18, 218a, and 218b are disposed in the robot main bodies 10 and 210 as first batteries, and the battery 25 is disposed in the mover 20 as a second battery has been shown in the aforementioned first, second, and third embodiments, the present disclosure is not limited to this. In the present disclosure, the first battery may not be disposed in the robot main body. When the robot main body moves integrally with the mover, the second battery disposed in the mover may be used as a drive source, and electric power for operating each portion of the robot main body may be supplied from the second battery. Furthermore, when the mover is moved separately from the robot main body, a connector for supplying electric power may be provided on a stand on which the robot main body is placed, and electric power may be supplied via the stand. Alternatively, a power cable may be connected to the robot main body, and electric power may be supplied from an electrical outlet provided on the wall surface or the like. Furthermore, when the mover moves separately from the first robot arm and the second robot arm as in the second embodiment, batteries or power sources for supplying electric power to the first robot arm and the second robot arm may be disposed in stands or the like to which the first robot arm and the second robot arm are fixed, respectively.

While the example in which the mounts 16 and 216 of the robot main bodies 10 and 210 are fixed to the bases 21 of the movers 20 and 220 by the fasteners such as screws has been shown in the aforementioned first, second, and third embodiments, the present disclosure is not limited to this. In the present disclosure, the robot main body may be attached to the mover by engaging with an engaging portion or the like instead of the fasteners. The robot main body may not be fixed to the mover, but may be placed on the mover such that the robot main body and the mover move integrally. Furthermore, the robot main body may be unfixed from the mover by the operation of at least one of the robot main body and the mover. That is, the operation of the robot itself may enable the mover to switchably move integrally with the robot main body and move separately from the robot main body. For example, the robot main body may be switchable between being separated from the mover and being disposed integrally with the mover by operating the robot arms of the robot main body. For example, end effectors that perform the fastening operation may be attached to the robot arms, and the operations of fastening and unfastening the mount to and from the base, and the operations of fastening and unfastening the mount to and from the stand may be performed by operating the robot arms. Alternatively, the mover may switchably move integrally with the robot main body and move separately from the robot main body by disposing an actuator separate from the robot arms in either the robot main body or the mover.

While the example in which the robot main bodies 10 and 210 are attached to the stands 40 and 240 placed on the floor when the movers 20 and 220 are moved separately from the robot main bodies 10 and 210 has been shown in the aforementioned first, second, and third embodiments, the present disclosure is not limited to this. In the present disclosure, when the mover is moved separately from the robot main body, the robot main body may be fixed directly to the floor. Alternatively, the robot main body may be placed on the floor without being fixed. Furthermore, when the mover is moved separately from the robot main body, the robot main body may be placed on a location other than the floor, such as the wall surface or the ceiling.

While the example in which when the movers 20 and 220 move separately from the robot main bodies 10 and 210, the robot main bodies 10 and 210 perform the predetermined task operations while the movers 20 and 220 are moving has been shown in the aforementioned first, second, and third embodiments, the present disclosure is not limited to this. In the present disclosure, the operation of the robot main body may be stopped while the mover is moving. Even in such a case, the mover is moved separately from the robot main body such that the number of objects placed on the mover instead of the robot main body can be increased when a transportation task that involves movement is performed, for example, and thus the degree of freedom of robot operation can be improved when a plurality of types of tasks are performed.

While the example in which the head 11 is removable from the torso 12 such that the imager 31 as the main body imager is switchable between being attached to the robot main bodies 10 and 210 and being separated from the robot main body 10 has been shown in the aforementioned first, second, and third embodiments, the present disclosure is not limited to this. In the present disclosure, the main body imager may not be separatable from the robot main body. Furthermore, the imager for capturing images may not be disposed on the robot main body. A sensor other than the imager for capturing images may be disposed on the robot main body. For example, a sensor such as a photoelectronic sensor, a capacitance sensor, or an ultrasonic sensor may be disposed on the robot main body. Furthermore, when the imager is disposed on the robot main body, one or more imagers may be disposed anywhere on the robot main body, such as on the front and back of the head of the robot main body, the front and back of the torso, or various portions of the robot arms. The operations of the robot main body including the robot arms and the mover may be controlled based on images captured by one or more imagers disposed on the robot main body. While an example in which the robot main body is imaged from a position spaced apart from the robot main body has been shown, a path of movement of the mover may be imaged by the imager that is spaced apart from the robot main body and captures images. For example, an imager is disposed on the upper side, such as on the ceiling such that a bird's-eye view of the path of movement of the mover can be acquired, and thus the accuracy of the operation of the mover can be improved based on the bird's-eye view.

While the example in which the imager 35 is disposed as a mobile imager on the movers 20 and 220 has been shown in the aforementioned first, second, and third embodiments, the present disclosure is not limited to this. In the present disclosure, the mobile imager may not be disposed on the mover. A sensor other than the imager for capturing images may be disposed on the mover. For example, a sensor such as a photoelectronic sensor, a capacitance sensor, or an ultrasonic sensor may be disposed on the mover. Furthermore, when the imager is disposed on the mover, the imager may be disposed on the front or back of the mover. In such a case, imagers may be disposed at a plurality of locations on the front, side, and back of the mover.

While the example in which the touch panel 11a is disposed on the head 11 as an operation unit for receiving input operations has been shown in the aforementioned first, second, and third embodiments, the present disclosure is not limited to this. In the present disclosure, the operation unit that receives input operations may be disposed on the mover. Alternatively, the operation unit may not be disposed on the robot. Operations for controlling the operation of the robot may be received by input operations on a control device disposed separately from the robot. A lever, a dial, a joystick, a foot switch, or a push button switch may be disposed as the operation unit. Alternatively, a microphone for receiving voice instructions rather than input operations may be disposed on the robot. Alternatively, a display that displays information separately from the operation unit may be disposed instead of the touch panel. Alternatively, the operation unit, the display, or the touch panel may be disposed on the torso or the robot arm. The display or the touch panel may be disposed on the mover.

While the example in which the first arm placement portion 212b on which the robot arm 13 as a first robot arm is placed moves integrally with the mover 220, and the second arm placement portion 212c on which the robot arm 14 as a second robot arm is placed is fixed separately from the mover 220 such that the robot arms 13 and 14 operate independently of each other while separated from each other has been shown in the aforementioned second embodiment, the present disclosure is not limited to this. In the present disclosure, the first robot arm may be separated from the mover while the second robot arm may move integrally with the mover. Alternatively, the first robot arm and the second robot arm may be disposed at separate locations, and be fixed while separated from the mover.

While the example in which the movers 20 and 220 include the wheels 22 as wheel members has been shown in the aforementioned first, second, and third embodiments, the present disclosure is not limited to this. In the present disclosure, the mover may include a moving mechanism such as a crawler, instead of the wheels as the wheel member. Alternatively, the mover may include a drive mechanism that is movable in all directions, such as Mecanum wheels or omni wheels.

While the example in which the robot arm 13 as a first robot arm and the robot arm 14 as a second robot arm, which are 6-axis vertical articulated arms, are disposed has been shown in the aforementioned first, second, and third embodiments, the present disclosure is not limited to this. In the present disclosure, the robot may include one robot arm or three or more robot arms. Alternatively, each of the robot arms, including the first robot arm and the second robot arm, may be a vertical articulated arm with five or less axes, or seven or more axes. Instead of the vertical articulated arms, horizontal articulated robot arms may be provided. Furthermore, the end effectors mounted on the robot arms are not limited to hands that grasp an object, but may be end effectors that perform machining, or operate a device.

While the example in which the meal 103 and the beverage 203 are transported by moving the movers 20 and 220 while the meal 103 and the beverage 203 are placed as objects to be transported on the platforms 21a and 221a disposed in the bases 21 of the movers 20 and 220 has been shown in the aforementioned first and second embodiments, the present disclosure is not limited to this. In the present disclosure, the delivery operation may be performed in which the mover transports a package as an object to be transported. Alternatively, the object to be transported may be placed on a movable platform such as a cart that is disposed separately from the mover, and the object to be transported may be transported by moving the movable platform using the mover. Furthermore, when the mover and the robot main body move integrally, the robot main body is attached to the upper surface of the mover, and when the mover is moved separately from the robot main body, the robot main body is removed, and thus the size of the platform in an upper portion of the base may be increased. Furthermore, when the mover is moved separately from the robot main body, a shelf-shaped member may be placed on the mover.

While the example in which the robot 100 and the robot 200 are disposed in the meal serving system 101 in which the meal 103 is cooked, transported, and served has been shown in the aforementioned first and second embodiments, and the example in which the robot 300 is disposed in the patrol system 301 in which patrols are performed has been shown in the aforementioned third embodiment, the present disclosure is not limited to this. In the present disclosure, the robot may be disposed in a system in which various services such as nursing care, medical care, cleaning, security, guidance, rescue, cooking, product provision, and logistics are performed. For example, equipment or facilities may be inspected by capturing images using the mobile imager that is disposed on the mover while the mover is moving.

While the example in which the portion 216a, the portion 216b, and the portion 216c of the mount 216 are disposed on the central portion 212a, the first arm placement portion 212b, and the second arm placement portion 212c of the torso 212, respectively has been shown in the aforementioned second embodiment, the present disclosure is not limited to this. In the present disclosure, the first robot arm and the second robot arm may be attached to the shoulder of the torso of the robot main body. That is, when the first robot arm and the second robot arm each move integrally with the mover, the torso of the robot main body may be attached to the mover, and the first robot arm and the second robot arm may each be attached to the torso of the robot main body attached to the mover. In such a case, the mover may move separately from the first robot arm and the second robot arm by separating the first robot arm and the second robot arm from the torso of the robot main body attached to the mover.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### Aspects

It will be appreciated by those skilled in the art that the exemplary embodiments described above are specific examples of the following aspects.

### Item 1

A robot comprising:
a robot main body including a robot arm; and
a mover configured to switchably move integrally with the robot main body and move separately from the robot main body.

### Item 2

The robot according to item 1, wherein the mover includes a platform on which an object to be transported is placed, the object being separate from the robot main body.

### Item 3

The robot according to item 1 or 2, further comprising:
a robot controller disposed in the robot main body and configured or programmed to control operation of the robot arm; and
a mobile controller disposed in the mover separately from the robot controller and configured or programmed to control movement of the mover.

### Item 4

The robot according to any one of items 1 to 3, wherein
the mover includes a base to which the robot main body is attached when the mover moves integrally with the robot main body; and
the robot main body includes a mount to be attached to the base of the mover.

### Item 5

The robot according to item 4, wherein the robot main body is fixed separately from the mover by attaching the mount to a stand placed on a floor separately from the mover when the mover moves separately from the robot main body.

### Item 6

The robot according to any one of items 1 to 5, wherein the robot main body is configured to perform a predetermined task operation by operating the robot arm when the mover moves separately from the robot main body.

### Item 7

The robot according to any one of items 1 to 6, wherein
the robot arm includes a first robot arm and a second robot arm that are different from each other; and
the first robot arm and the second robot arm are configured to operate independently of each other while separated from each other.

### Item 8

The robot according to item 7, wherein
the mover is configured to switchably move integrally with the first robot arm and the second robot arm and move separately from at least one of the first robot arm and the second robot arm; and
the first robot arm and the second robot arm are configured to operate independently of each other when the mover moves separately from at least one of the first robot arm and the second robot arm.

### Item 9

The robot according to any one of items 1 to 8, further comprising:
a main body imager switchable between being attached to the robot main body and being separated from the robot main body and configured to capture an image.

### Item 10

The robot according to any one of items 1 to 9, further comprising:
a mobile imager on the mover configured to move integrally with the mover.

### Item 11

The robot according to any one of items 1 to 10, further comprising:
an operation unit on at least one of the robot main body and the mover to receive an input operation.

### Item 12

The robot according to any one of items 1 to 11, further comprising:
a first battery disposed in the robot main body and configured to serve as a power source for operation of the robot arm; and
a second battery disposed in the mover separately from the first battery and configured to serve as a power source for movement of the mover.

1. A robot comprising:
a robot main body including a robot arm; and
a mover configured to switchably move integrally with the robot main body and move separately from the robot main body.

2. The robot according to claim 1, wherein the mover includes a platform on which an object to be transported is placed, the object being separate from the robot main body.

3. The robot according to claim 1, further comprising:
a robot controller disposed in the robot main body and configured or programmed to control operation of the robot arm; and
a mobile controller disposed in the mover separately from the robot controller and configured or programmed to control movement of the mover.

4. The robot according to claim 1, wherein
the mover includes a base to which the robot main body is attached when the mover moves integrally with the robot main body; and
the robot main body includes a mount to be attached to the base of the mover.

5. The robot according to claim 4, wherein the robot main body is fixed separately from the mover by attaching the mount to a stand placed on a floor separately from the mover when the mover moves separately from the robot main body.

6. The robot according to claim 1, wherein the robot main body is configured to perform a predetermined task operation by operating the robot arm when the mover moves separately from the robot main body.

7. The robot according to claim 1, wherein
the robot arm includes a first robot arm and a second robot arm that are different from each other; and
the first robot arm and the second robot arm are configured to operate independently of each other while separated from each other.

8. The robot according to claim 7, wherein
the mover is configured to switchably move integrally with the first robot arm and the second robot arm and move separately from at least one of the first robot arm and the second robot arm; and
the first robot arm and the second robot arm are configured to operate independently of each other when the mover moves separately from at least one of the first robot arm and the second robot arm.

9. The robot according to claim 1, further comprising:
a main body imager switchable between being attached to the robot main body and being separated from the robot main body and configured to capture an image.

10. The robot according to claim 1, further comprising:
a mobile imager on the mover configured to move integrally with the mover.

11. The robot according to claim 1, further comprising:
an operation unit on at least one of the robot main body and the mover to receive an input operation.

12. The robot according to claim 1, further comprising:
a first battery disposed in the robot main body and configured to serve as a power source for operation of the robot arm; and
a second battery disposed in the mover separately from the first battery and configured to serve as a power source for movement of the mover.
